(19) United States
(12) Patent Application Publication
(10) Pub. No.: US 2020/0223378 A1
(43) Pub. Date: Jul. 16, 2020

(54) POWER FEEDING DEVICE FOR SEATS

(71) Applicant: Yazaki Corporation, Tokyo (JP)

(72) Inventor: Daiki Mushiake, Shizuoka (JP)

(21) Appl. No.: 16/706,606

(22) Filed: Dec. 6, 2019

(30) Foreign Application Priority Data
Jan. 10, 2019 (JP) 2019-002402

(51) Int. Cl. B60R 16/027; H02J 50/10; H01F 38/14

(52) U.S. Cl. CPC B60R 16/027; B60N 2/06; H01F 38/14; H02J 50/10

(57) ABSTRACT

A power feeding device for seats includes a first power transmission coil that is provided so as to be slidable and movable together with a seat installed on a vehicle floor, is supplied with electric power from a power source of the vehicle floor side, and is capable of transmitting electric power in a non-contact manner, and a second power transmission coil that is provided on a rotating shaft of the seat so as to be rotatable together with the seat with the rotating shaft as a rotation center, is positioned facing the first power transmission coil, is capable of transmitting electric power with the first power transmission coil in a non-contact manner, and is capable of supplying electric power received from the first power transmission coil to an electrical component provided on the seat.

### CROSS-REFERENCE TO RELATED APPLICATION(S)

The present application claims priority to and incorporates by reference the entire contents of Japanese Patent Application No. 2019-002402 filed in Japan on Jan. 10, 2019.

### BACKGROUND OF THE INVENTION

### 1. Field of the Invention

The present invention relates to a power feeding device for seats.

### 2. Description of the Related Art

As a conventional power feeding device for a seat provided on a vehicle, Japanese Patent Application Laid-open No. 2013-023069 discloses a power feeding device for slide seats that feeds power by electrically connecting a vehicle body side of a vehicle with a slide seat side that is slidable in a predetermined direction with respect to the vehicle body, for example.

Incidentally, in the power feeding device for slide seats described in the above-described Japanese Patent Application Laid-open No. 2013-023069, a configuration that further allows various seat arrangements has been desired, for example.

### SUMMARY OF THE INVENTION

The present invention has been made in view of the above-mentioned circumstances, and an object of the invention is to provide a power feeding device for seats capable of properly feeding power to a seat.

In order to achieve the above mentioned object, a power feeding device for seats according to one aspect of the present invention includes a first power transmission coil that is provided so as to be slidable and movable together with a seat that is installed on a vehicle floor, is supplied with electric power from a power source on the vehicle floor side, and is capable of transmitting electric power in a non-contact manner; and a second power transmission coil that is provided on a rotating shaft of the seat so as to be rotatable together with the seat with the rotating shaft as a rotation center, is positioned facing the first power transmission coil, is capable of transmitting electric power with the first power transmission coil in a non-contact manner, and is capable of supplying electric power received from the first power transmission coil to an electric component provided on the seat.

According to another aspect of the present invention, in the power feeding device for seats, it is possible to further include a first signal transmission antenna that is provided so as to be slidable and movable together with the seat and is capable of transmitting a signal in a non-contact manner; and a second signal transmission antenna that is provided on the rotating shaft of the seat so as to be rotatable together with the seat with the rotating shaft as a rotation center and is capable of transmitting a signal in a non-contact manner with the first signal transmission antenna.

According to still another aspect of the present invention, in the power feeding device for seats, it is possible to further include a mounting member that is positioned facing an end portion of the rotating shaft and is slidable and movable together with the seat, wherein the first power transmission coil is provided on the mounting member, and the second power transmission coil is provided on the end portion of the rotating shaft facing the mounting member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic perspective view representing a schematic configuration of a seat that a power feeding device for seats according to an embodiment has been applied to;

FIG. 2 is a schematic exploded perspective view representing a schematic configuration of the seat that the power feeding device for seats in the embodiment has been applied to;

FIG. 3 is a schematic partial front view representing a schematic configuration of the seat that the power feeding device for seats in the embodiment has been applied to;

FIG. 4 is a partial sectional perspective view including a seat rail of the seat that the power feeding device for seats in the embodiment has been applied to;

FIG. 5 is a schematic block diagram representing a schematic configuration of the power feeding device for seats in the embodiment;

FIG. 6 is a schematic partial sectional view representing a schematic configuration of the power feeding device for seats in the embodiment; and

FIG. 7 is a schematic sectional view representing a schematic configuration of the power feeding device for seats in the embodiment.

### DETAILED DESCRIPTION OF THE PREFERRED EMBODIMENT

The following describes in detail an exemplary embodiment according to the present invention based on the accompanying drawings. The invention, however, is not intended to be limited by the embodiment. The constituent elements in the following embodiment include elements that are substitutable and easily achieved by a person skilled in the art, or elements that are substantially the same as the constituent elements.

Each of the drawings described in the following is illustrated by omitting portions other than principal portions of a seat as appropriate. In the following description, out of a first direction, a second direction, and a third direction intersecting with one another, the first direction is referred to as a “front-and-rear direction X”, the second direction is referred to as a “width direction Y”, and the third direction is referred to as a “height direction Z”. The front-and-rear direction X, the width direction Y, and the height direction Z are orthogonal to one another. Typically, in a state where a power feeding device for seats is installed on a vehicle and the vehicle is positioned on a horizontal plane, the front-and-rear direction X and the width direction Y lie along the horizontal direction and the height direction Z lies along the vertical direction. The front-and-rear direction X corresponds, typically, to a whole length direction of the vehicle on which the power feeding device for seats is installed, and in this case, corresponds to a direction along a sliding direction of the seat. The width direction Y corresponds, typically, to a whole width direction of the vehicle on which the power feeding device for seats is installed. The height direction Z corresponds, typically, to a vehicle height direction of the vehicle on which the power feeding device for seats is installed. The respective directions used in the following description are the directions in a state in which various units are assembled with one another, unless otherwise specifically noted.

### Embodiment

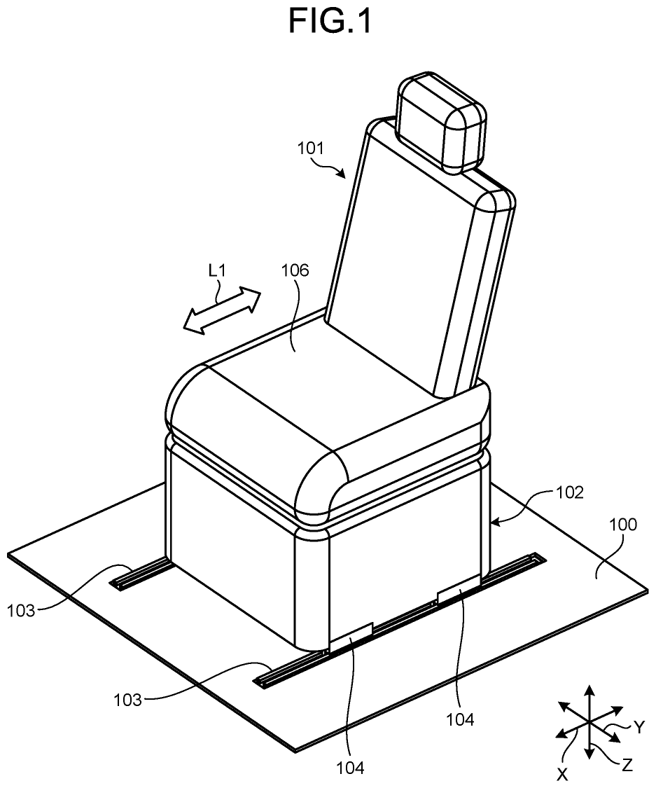

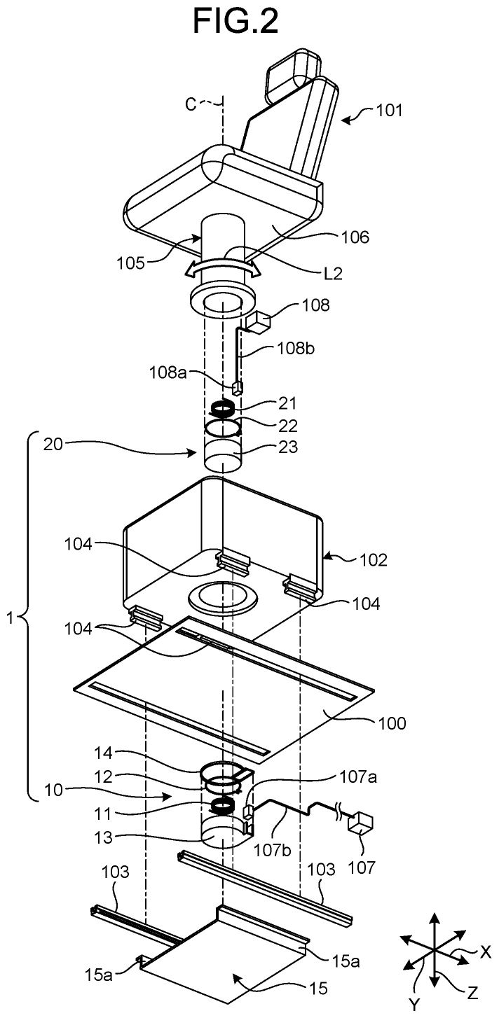

A power feeding device 1 for seats of the present embodiment illustrated in FIG. 1 and FIG. 2 constitutes a part of an in-vehicle power feeding system that performs power feeding (supply of electric power) to a seat 101 provided on a vehicle floor 100 constituting a floor surface of a vehicle.

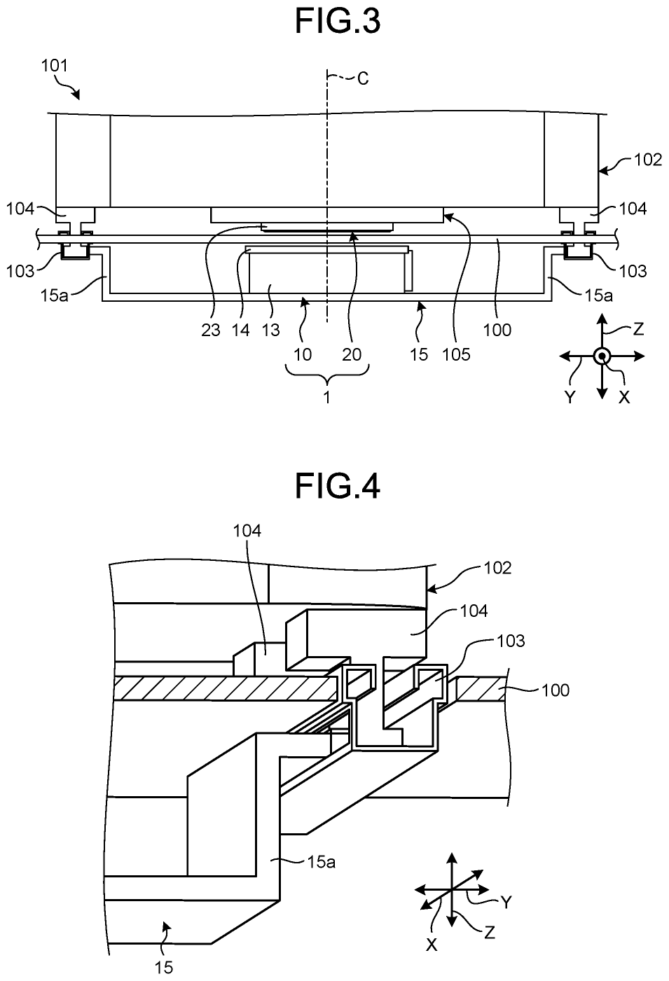

The seat 101 is the one on which an occupant of the vehicle sits, and is provided so as to be slidable and movable along a sliding direction L1 (see FIG. 1) with respect to the vehicle floor 100. The sliding direction L1 of the seat 101 of the present embodiment is a direction along the front-and-rear direction X. The seat 101 is supported on seat rails 103 provided on the vehicle floor 100 via a seat base 102. The seat base 102 is positioned on the lower side of the height direction Z of the seat 101 and is a pedestal portion that supports the seat 101. The seat base 102 is provided with a plurality of sliders 104 on the lower surface of the height direction Z. The sliders 104 are provided two each on each side, that is, a total of four, along the front-and-rear direction X of the seat base 102. The seat rails 103 are guide rails for guiding the sliding movement along the front-and-rear direction X of the seat 101. The seat rails 103 are provided extending in the front-and-rear direction X on the vehicle floor 100. The seat rails 103 are provided in a pair spaced apart along the width direction Y. Each seat rail 103 is, as illustrated in FIG. 3 and FIG. 4, fitted with two sliders 104 and guides the relevant sliders 104 along the sliding direction L1 (the front-and-rear direction X). With the above-described configuration, the seat 101 is supported by each of the seat rails 103 via the seat base 102 and the sliders 104, and is slidable and movable along the sliding direction L1 on each of the relevant seat rails 103. The seat 101 may be configured to be slidable and movable electrically or may be configured to be slidable and movable manually.

Moreover, the seat 101 of the present embodiment includes a rotating shaft 105 and is configured to be rotatable in a rotational direction L2 (see FIG. 2) with the rotating shaft 105 as a rotation center. The rotating shaft 105 is provided, in the seat 101, on the seat surface portion 106 on which the occupant sits. The rotating shaft 105 is formed so as to project toward the lower side in the height direction Z from the lower surface in the height direction Z of the seat surface portion 106. The rotating shaft 105 is formed in a substantially cylindrical shape for which a central axis line C lies along the height direction Z. The rotating shaft 105 is supported on the seat base 102 to be rotatable with the central axis line C as the rotation center. With the above-described configuration, the seat 101 is configured to be rotatable in the rotational direction L2 at any desired angle with the central axis line C of the rotating shaft 105 as the rotation center. The seat 101 is rotatable through 360° with the central axis line C of the rotating shaft 105 as the rotation center. The seat 101 may be configured to be rotatable electrically or may be configured to be rotatable manually.

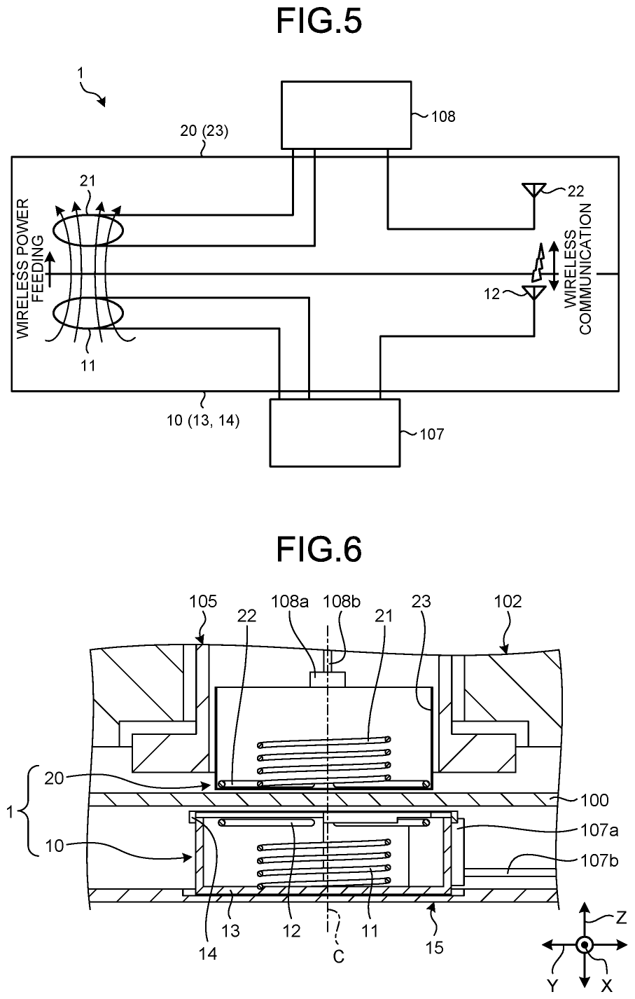

The power feeding device 1 for seats feeds the power, as in the foregoing, to the seat 101 provided on the vehicle floor 100 so as to be slidable and movable along the sliding direction L1 and to be rotatable in the rotational direction L2. The power feeding device 1 for seats of the present embodiment is a wireless power feeding system in which at least a part of a feeding line between vehicle-side equipment 107 on the vehicle floor 100 side and an electrical component 108 provided on the seat 101 side is made wireless, and made to be non-contact power transmission. The power feeding device 1 for seats, as illustrated in FIG. 2, FIG. 3, FIG. 5, and others, includes a vehicle-side device 10 and a seat-side device 20. The power feeding device 1 for seats transmits electric power from the vehicle-side equipment 107 in a non-contact manner between the vehicle-side device 10 and the seat-side device 20 and supplies the electric power to the electrical component 108. The power feeding device 1 for seats of the present embodiment further has a function of performing wireless communication between the vehicle-side equipment 107 and the electrical component 108, in addition to the power transmission in a non-contact manner between the vehicle-side equipment 107 and the electrical component 108. That is, the power feeding device 1 for seats of the present embodiment transmits in a non-contact manner both electric power and signals between the vehicle-side equipment 107 and the electrical component 108.

The vehicle-side equipment 107 includes various equipment installed on the vehicle and provided on the vehicle floor 100 side (vehicle body side). The vehicle-side equipment 107 is made up of a power source such as a battery and a generator that is a source of electric power supply, and a vehicle-side electronic control unit (ECU) that performs various control on the vehicle floor 100 side (vehicle body side), for example. The vehicle-side equipment 107 is installed on the vehicle floor 100 side and is configured not to move together with the seat 101. Meanwhile, the electrical component 108 is an electronic device that operates by the electric power supplied from the vehicle-side equipment 107. The electrical component 108 is made up of a heater for heating the seat surface portion 106, various actuators such as electric motors that drive various units, various sensors that detect a load and the like, various switches that receive operating input, a power distributor that distributes the electric power to other portions, a seat-side ECU that performs various control on the seat 101 side, or the like, for example. The electrical component 108 is installed on the seat 101 and is configured to be movable together with the seat 101. The vehicle-side equipment 107 and the electrical component 108 are in a positional relation of moving relatively along with the sliding movement and rotation of the seat 101. In FIG. 2, FIG. 5, and others, although only one each of the vehicle-side equipment 107 and the electrical component 108 is illustrated simply, the embodiments are not limited thereto and multiple numbers of the vehicle-side equipment 107 and the electrical components 108 may be provided.

Specifically, the vehicle-side device 10 constitutes, in the wireless power feeding system, a power transmission unit of a supply source side of the electric power. The vehicle-side device 10 includes a first power transmission coil 11, a first signal transmission antenna 12, an under cover 13, and an upper cover 14. The vehicle-side device 10 is unitized as the power transmission unit, as the first power transmission coil 11 and the first signal transmission antenna 12 are installed on the under cover 13 and the upper cover 14.

Meanwhile, the seat-side device 20 constitutes, in the wireless power feeding system, a power receiving unit of a supply destination side of the electric power. The seat-side device 20 includes a second power transmission coil 21, a second signal transmission antenna 22, and an under cover 23. The seat-side device 20 is unitized as the power receiving unit, as the second power transmission coil 21 and the second signal transmission antenna 22 are installed on the under cover 23.

The vehicle-side device 10 includes an electronic circuit for implementing various functions in the vehicle-side device 10. Similarly, the seat-side device 20 may further include an electronic circuit for implementing various functions in the seat-side device 20.

The first power transmission coil 11 is a conductor coil capable of transmitting electric power with the second power transmission coil 21 in a non-contact manner. The second power transmission coil 21 is a conductor coil capable of transmitting electric power with the first power transmission coil 11 in a non-contact manner. That is, the first power transmission coil 11 and the second power transmission coil 21 are capable of transmitting electric power between the two in a non-contact manner. The first power transmission coil 11 and the second power transmission coil 21 may be made up of what is called a spiral type conductor coil or may be made up of a solenoid (helical) type conductor coil. The spiral type conductor coil is formed by, with a central axis line as the center, spirally winding an element wire having conductivity around the central axis line. Meanwhile, the solenoid type conductor coil is formed by, with a central axis as the center, helically winding an element wire having conductivity around the central axis line. In this case, the first power transmission coil 11 and the second power transmission coil 21 are made up of solenoid type conductor coils that are formed by helically winding around the central axis line C, for example. The first power transmission coil 11 and the second power transmission coil 21 are, in a state of facing each other, able to transmit electric power in a non-contact manner by various methods such as electromagnetic induction method, electromagnetic-field resonance method, and the like. One of the first power transmission coil 11 and the second power transmission coil 21 becomes a power transmitting coil that transmits electric power and the other becomes a power receiving coil that receives the electric power. In this case, in the first power transmission coil 11 and the second power transmission coil 21, the first power transmission coil 11 that is the coil of the power transmission unit side becomes the power transmission coil, and the second power transmission coil 21 that is the coil of the power receiving unit side becomes the power receiving coil. The first power transmission coil 11 is electrically connected to the vehicle-side equipment 107 via an electronic circuit, a connector 107a, wiring materials (power supply line, grounding wire) 107b, and the like, for example, and electric power is supplied from a power source included in the vehicle-side equipment 107 on the vehicle floor 100 side. The second power transmission coil 21 is electrically connected to the electrical component 108 provided on the seat 101 via an electronic circuit, a connector 108a, wiring materials (power supply line, grounding wire) 108b, and the like, for example, and is able to supply the electric power received from the first power transmission coil 11 to the electrical component 108.

The first signal transmission antenna 12 is a conductor coil capable of transmitting a signal with the second signal transmission antenna 22 in a non-contact manner. The second signal transmission antenna 22 is a conductor coil capable of transmitting a signal with the first signal transmission antenna 12 in a non-contact manner. That is, the first signal transmission antenna 12 and the second signal transmission antenna 22 are capable of transmitting a signal between the two in a non-contact manner (wireless communication). The first signal transmission antenna 12 and the second signal transmission antenna 22 are made up of conductor wires that are annularly formed around the central axis line C, for example. The first signal transmission antenna 12 and the second signal transmission antenna 22 constitute a communication coupler that emits (transmits) high-frequency energy into space as an electromagnetic wave (radio wave) and converts (receives) the electromagnetic wave (radio wave) in the space into high-frequency energy mutually. The first signal transmission antenna 12 and the second signal transmission antenna 22 are, in a state of facing each other, able to transmit a signal in a non-contact manner by various methods. The first signal transmission antenna 12 and the second signal transmission antenna 22 can typically employ a short-range wireless system such as Bluetooth (registered trademark), near field communication (NFC), and the like, but the embodiments are not limited thereto and a wide-area wireless system, a narrow-area wireless system, and the like may be employed. One of the first signal transmission antenna 12 and the second signal transmission antenna 22 becomes a transmission antenna that transmits a signal and the other becomes a receiving antenna that receives the signal. The first signal transmission antenna 12 is electrically connected to the vehicle-side equipment 107 via the electronic circuit, the connector 107a, the wiring materials (communication line) 107b, and the like, for example, and is able to transmit a signal between the first signal transmission antenna 12 and the vehicle-side equipment 107. The second signal transmission antenna 22 is electrically connected to the electrical component 108 provided on the seat 101 via the electronic circuit, the connector 108a, the wiring materials (communication line) 108b, and the like, for example, and is able to transmit a signal between the second signal transmission antenna 22 and the electrical component 108.

In each of the under cover 13, the upper cover 14, and the under cover 23, various units of the vehicle-side device 10 and the seat-side device 20 are installed. The under cover 13, the upper cover 14, and the under cover 23 are formed of a resin material having insulating properties, for example. The under cover 13 and the under cover 23 are formed in a substantially cylindrical shape for which both central axis lines lie along the height direction Z. In both the under cover 13 and the under cover 23, the upper side in the height direction Z is open and the lower side in the height direction Z is closed.

The under cover 13 accommodates therein the first power transmission coil 11, the first signal transmission antenna 12, and the like, and the upper cover 14 is attached to the opening on the upper side in the height direction Z. The first power transmission coil 11 and the first signal transmission antenna 12 are, as illustrated in FIG. 6, installed on the inside of the under cover 13 such that the central axis lines thereof align with the central axis line of the under cover 13. The first power transmission coil 11 is installed via various fasteners or the like in the vicinity of the closed-end portion on the lower side in the height direction Z of the under cover 13. The first signal transmission antenna 12 is installed via various fasteners or the like in the vicinity of the upper cover 14 on the upper side in the height direction Z of the under cover 13.

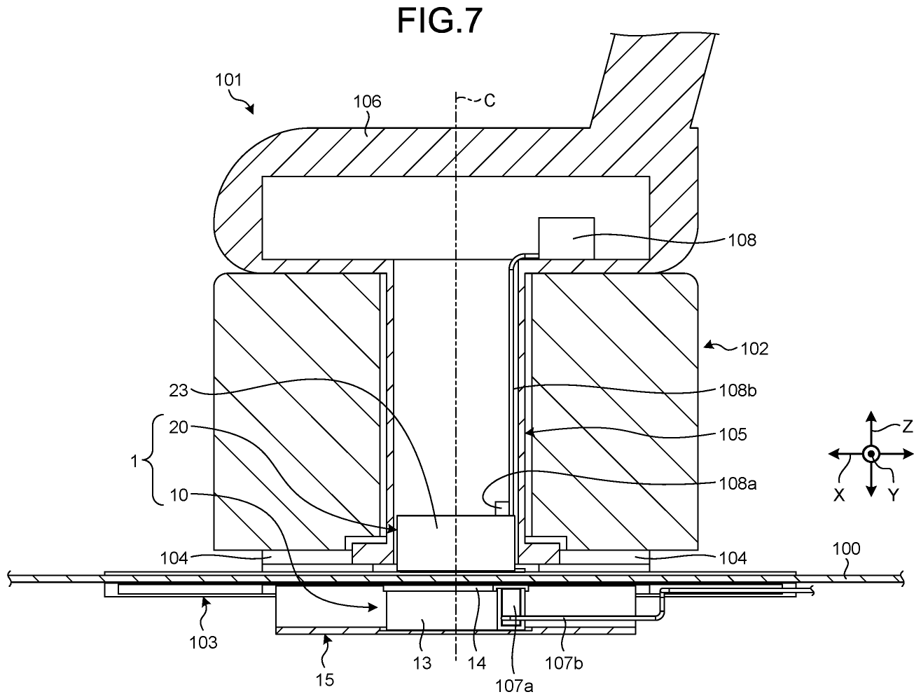

The under cover 13 is then provided so as to be slidable and movable together with the seat 101. In this case, as illustrated in FIG. 2, FIG. 3, FIG. 4, FIG. 6, and FIG. 7, the under cover 13 is configured to slide and move together with the seat 101 via a mounting member 15 and not integrally rotate together with the seat 101. The mounting member 15 is a member formed in a tray-like shape. In the mounting member 15, each of rising portions 15a on both end portions in the width direction Y is supported by the respective sliders 104. The mounting member 15 is, in a state where the rising portions 15a are supported by the respective sliders 104, positioned at a hollow portion on the lower side in the height direction Z of the vehicle floor 100 (what is called an underfloor). The mounting member 15 is positioned facing the end portion of the lower side of the rotating shaft 105 along the height direction Z. The mounting member 15 slides and moves along the sliding direction L1 together with the respective sliders 104 along with the sliding movement of the seat 101. Then, in the mounting member 15, the under cover 13 is installed on the upper surface in the height direction Z. The under cover 13 is, in a state installed on the mounting member 15, positioned in the hollow portion on the lower side in the height direction Z of the vehicle floor 100 together with the mounting member 15. The under cover 13 is installed such that the central axis line thereof aligns with the central axis line C that is the rotation center of the seat 101. With the above-described configuration, the under cover 13 is configured to slide and move along the sliding direction L1 together with the seat 101 via the mounting member 15 and not integrally rotate together with the seat 101. As a result, the first power transmission coil 11 and the second power transmission coil 21 that are installed on the under cover 13 are provided on the mounting member 15 and are provided so as to slide and move along the sliding direction L1 together with the seat 101 and not integrally rotate together with the seat 101.

Meanwhile, the under cover 23 accommodates therein the second power transmission coil 21, the second signal transmission antenna 22, and the like. The second power transmission coil 21 and the second signal transmission antenna 22 are, as illustrated in FIG. 6, installed on the inside of the under cover 23 such that the central axis lines thereof align with the central axis line of the under cover 23. The second signal transmission antenna 22 is installed via various fasteners or the like in the vicinity of the closed-end portion on the lower side in the height direction Z of the under cover 23. The second power transmission coil 21 is installed via various fasteners or the like on the upper side in the height direction Z of the second signal transmission antenna 22.

The under cover 23 is then provided on the rotating shaft 105 of the seat 101 so as to be rotatable together with the seat 101 with the rotating shaft 105 as a rotation center. In this case, as illustrated in FIG. 2, FIG. 3, FIG. 6, and FIG. 7, the under cover 23 is, by being installed on the inside of the rotating shaft 105, configured to slide and move together with the seat 101 and integrally rotate together with the seat 101. In this case, the under cover 23 is provided at an end portion on the lower side (the lowermost end portion) in the height direction Z on the inside of the rotating shaft 105. The under cover 23 is installed such that the central axis line thereof aligns with the central axis C that is the rotation center of the seat 101. With the above-described configuration, the under cover 23 is configured to slide and move along the sliding direction L1 together with the seat 101 and integrally rotate together with the seat 101. As a result, the second power transmission coil 21 and the second signal transmission antenna 22 that are installed on the under cover 23 are provided at the end portion on the lower side in the height direction Z of the rotating shaft 105 facing the mounting member 15 and are provided so as to slide and move along the sliding direction L1 together with the seat 101 and integrally rotate together with the seat 101.

In the vehicle-side device 10 and the seat-side device 20 thus configured, as illustrated in FIG. 6 and FIG. 7, the under cover 13 and the under cover 23 are arranged in the above-described positional relation. With this configuration, the vehicle-side device 10 and the seat-side device 20 are positioned so that the first power transmission coil 11 and the first signal transmission antenna 12 face the second power transmission coil 21 and the second signal transmission antenna 22 along the central axis line C.

The above-described power feeding device 1 for seats can transmit electric power to the seat 101 from the vehicle-side equipment 107 with the first power transmission coil 11 and the second power transmission coil 21 in a non-contact manner and can supply the electric power to the electrical component 108 provided on the seat 101. In this case, the first power transmission coil 11 of the power transmission side is provided so as to be slidable and movable together with the seat 101, and the second power transmission coil 21 of the power receiving side is provided on the rotating shaft 105 of the seat 101 so as to be rotatable together with the seat 101. With this configuration, the power feeding device 1 for seats can properly feed the power to the seat 101 for which a variety of seat arrangement is possible by the sliding movement and rotation, regardless of the sliding position and rotational position of the seat 101. For example, when wiring materials are used for feeding the power to the seat 101, the sliding position and rotational position of the seat 101 tend to depend on the length of the wiring materials. However, the power feeding device 1 for seats can achieve optimal seat arrangement according to the taste of the occupant, as there is no limit in the sliding position and rotational position of the seat 101 achievable. Furthermore, the power feeding device 1 for seats can prevent the occurrence of abnormal noise due to the fluttering of the wiring materials.

In addition, the above-described power feeding device 1 for seats can perform wireless communication between the vehicle-side equipment 107 side and the electrical component 108 side with the first signal transmission antenna 12 and the second signal transmission antenna 22. As a result, the power feeding device 1 for seats can transmit and receive various information such as information concerning the seat 101 and the occupant, control information, and the like between the vehicle-side equipment 107 side and the electrical component 108 side.

In this case, in the above-described power feeding device 1 for seats, the first power transmission coil 11 and the first signal transmission antenna 12 are provided on the mounting member 15 via the under cover 13, and the second power transmission coil 21 and the second signal transmission antenna 22 are provided inside the end portion of the rotating shaft 105 via the under cover 23. With this configuration, the power feeding device 1 for seats can maintain optimal positional relation for the non-contact power feeding between the first power transmission coil 11 and the second power transmission coil 21 and the wireless communication between the first signal transmission antenna 12 and the second signal transmission antenna 22, regardless of the sliding position and rotational position of the seat 101. Furthermore, because the second power transmission coil 21 and the second signal transmission antenna 22 are arranged at the lowermost end portion in the height direction Z of the rotating shaft 105, the power feeding device 1 for seats can make the distances as minimum as possible to the first power transmission coil 11 and to the first signal transmission antenna 12. Accordingly, because it is possible to reduce the influence of external noise, the power feeding device 1 for seats can stably perform the non-contact power feeding between the first power transmission coil 11 and the second power transmission coil 21 and the wireless communication between the first signal transmission antenna 12 and the second signal transmission antenna 22.

The power feeding device for seats in the above-described embodiment of the present invention is not limited to the foregoing embodiment, and various modifications can be made within the scope stated in claims.

In the foregoing description, the sliding direction L1 of the seat 101 has been described as the direction along the front-and-rear direction X, but the embodiments are not limited thereto, and it may be a direction along the width direction Y.

In the foregoing description, the power feeding device 1 for seats has been described to have the function of performing the wireless communication and to include the first signal transmission antenna 12 and the second signal transmission antenna 22, in addition to the power transmission in a non-contact manner, but the embodiments are not limited thereto. The power feeding device 1 for seats may not include the first signal transmission antenna 12 or the second signal transmission antenna 22 and may have no function of performing wireless communication.

The power feeding device for seats according to the present embodiment can transmit electric power to the seat side from the power source side with the first power transmission coil and the second power transmission coil in a non-contact manner and can supply the electric power to the electrical component provided on the seat. In this case, the first power transmission coil of the power transmission side is provided so as to be slidable and movable together with the seat, and the second power transmission coil of the power receiving side is provided on the rotating shaft of the seat so as to be rotatable together with the seat. With this configuration, the power feeding device for seats has an effect in that it is possible to properly feed the power to the seat, regardless of the sliding position and rotational position of the seat.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power feeding device for seats comprising:
a first power transmission coil that is provided so as to be slidable and movable together with a seat that is installed on a vehicle floor, is supplied with electric power from a power source on the vehicle floor side, and is capable of transmitting electric power in a non-contact manner; and
a second power transmission coil that is provided on a rotating shaft of the seat so as to be rotatable together with the seat with the rotating shaft as a rotation center, is positioned facing the first power transmission coil, is capable of transmitting electric power with the first power transmission coil in a non-contact manner, and is capable of supplying electric power received from the first power transmission coil to an electric component provided on the seat.

2. The power feeding device for seats according to claim 1, further comprising:
a first signal transmission antenna that is provided so as to be slidable and movable together with the seat and is capable of transmitting a signal in a non-contact manner; and
a second signal transmission antenna that is provided on the rotating shaft of the seat so as to be rotatable together with the seat with the rotating shaft as a rotation center and is capable of transmitting a signal in a non-contact manner with the first signal transmission antenna.

3. The power feeding device for seats according to claim 1, further comprising:
a mounting member that is positioned facing an end portion of the rotating shaft and is slidable and movable together with the seat, wherein
the first power transmission coil is provided on the mounting member, and
the second power transmission coil is provided on the end portion of the rotating shaft facing the mounting member.

4. The power feeding device for seats according to claim 2, further comprising:
a mounting member that is positioned facing an end portion of the rotating shaft and is slidable and movable together with the seat, wherein
the first power transmission coil is provided on the mounting member, and
the second power transmission coil is provided on the end portion of the rotating shaft facing the mounting member.
